(19) United States
(12) Patent Application Publication
(10) Pub. No.: US 2018/0189919 A1
(43) Pub. Date: Jul. 5, 2018

(54) RIDE SHARING ROUTING AND ALLOCATION SYSTEM

(71) Applicant: Mobileoffer, Inc, Venice, CA (US)

(72) Inventors: Kurt Brendlinger, Santa Monica, CA (US); Anthony Wentzel, Santa Monica, CA (US)

(21) Appl. No.: 15/855,538

(22) Filed: Dec. 27, 2017

Related U.S. Application Data
(60) Provisional application No. 62/441,086, filed on Dec. 30, 2016.

(51) Int. Cl. G06Q 50/30; G06Q 30/02

(52) U.S. Cl. CPC G06Q 50/30; G06Q 30/0215; G06Q 30/0261; G06Q 30/0267

(57) ABSTRACT

A method of reconfiguring a rideshare application involves activating a master application and instructing a rideshare application to push a destination notification control to the master application. The master application display promotion controls associated with an area proximate with the destination, and sends a selected destination control to the rideshare application in response to receiving the input at one of the promotion controls, the selected destination control altering the destination of the rideshare application to a selected destination associated with the one of the promotion controls selected.

### CROSS-REFERENCE TO RELATED APPLICATIONS

This application claims benefit under 35 U.S.C. 119(e) to U.S. application Ser. No. 62/441,086, entitled “RIDE SHARING ROUTING AND ALLOCATION SYSTEM”, filed on Dec. 30, 2016, and incorporated herein by reference in its entirety.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a simplified system 100 in which a server 104 and a client device 106 are communicatively coupled via a network 102.

FIG. 2 illustrates an embodiment of a client device 106.

FIG. 3 illustrates an embodiment of a client device 106 executing a master application 202.

FIG. 4 illustrates an embodiment of selected destination environment 400.

FIG. 5 illustrates an embodiment of a re-configuration method 500.

FIG. 6 illustrates an embodiment of a mobile application reconfiguration process 600.

FIG. 7 illustrates an embodiment of a mobile application reconfiguration process 700.

FIG. 8 illustrates an embodiment of a process 800 executed at arrival at a promoted destination.

FIG. 9 illustrates an embodiment of a resource allocation process 900.

FIG. 10 illustrates an embodiment of an automated resource allocation 1000.

FIG. 11 is an example block diagram of a computing device 1100 that may incorporate embodiments of the present invention.

FIG. 12 illustrates an embodiment of a mobile device 1200.

### DETAILED DESCRIPTION

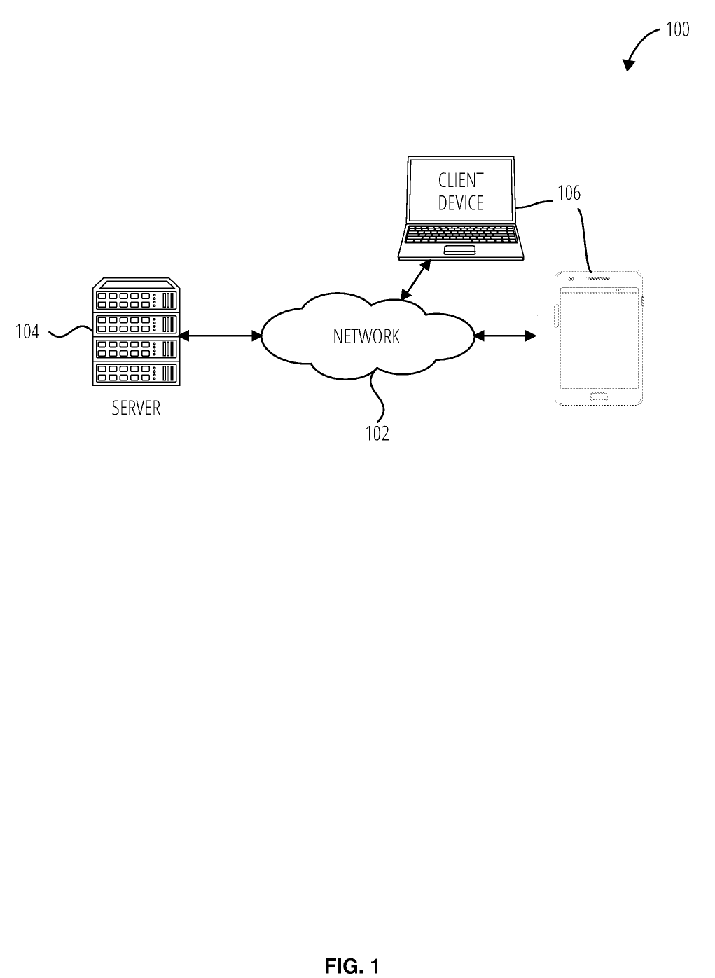

FIG. 1 illustrates a system 100 in which a server 104 and a client device 106 are connected to a network 102.

In various embodiments, the network 102 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, network 102 may also include a voice network that conveys not only voice communications, but also non-voice data such as Short Message Service (“SMS”) messages, as well as data communicated via various cellular data communication protocols, and the like.

In various embodiments, client device 106 may include desktop PCs, mobile phones, laptops, tablets, wearable computers, or other computing devices that are capable of connecting to network 102 and communicating with server 104, such as described herein.

In various embodiments, additional infrastructure (e.g., short message service centers, cell sites, routers, gateways, firewalls, and the like), as well as additional devices may be present. Further, in some embodiments, the functions described as being provided by some or all of server 104 and client device 106 may be implemented via various combinations of physical and/or logical devices. However, it is not necessary to show such infrastructure and implementation details in FIG. 1 in order to describe an illustrative embodiment.

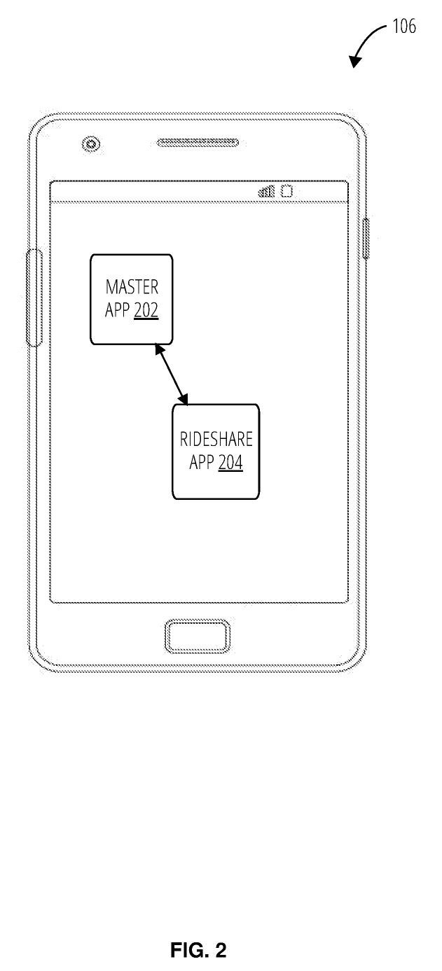

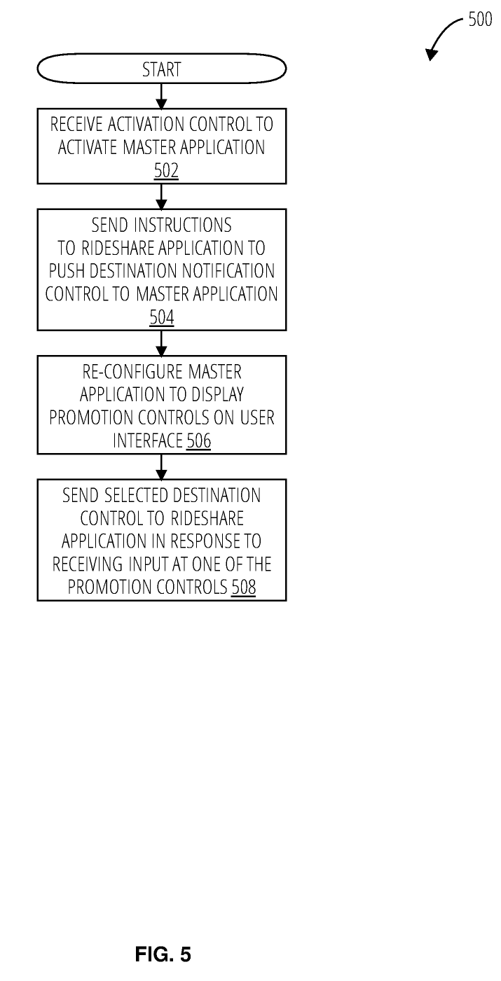

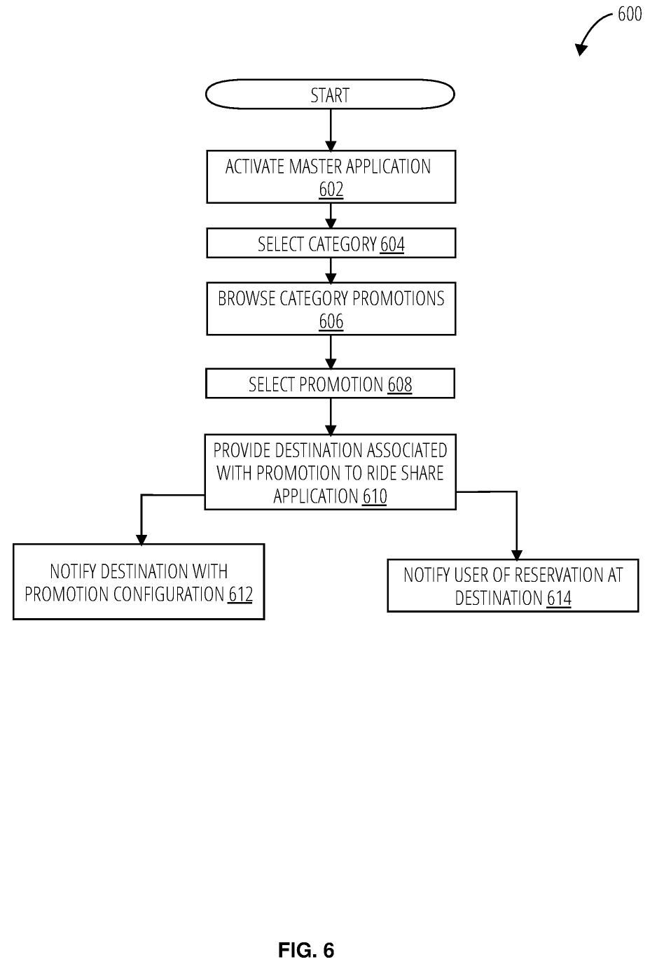

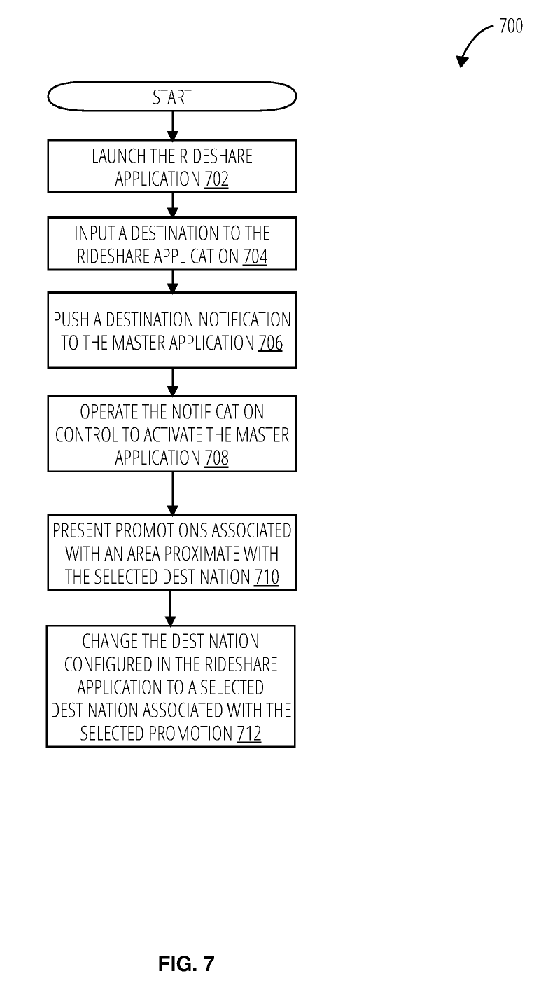

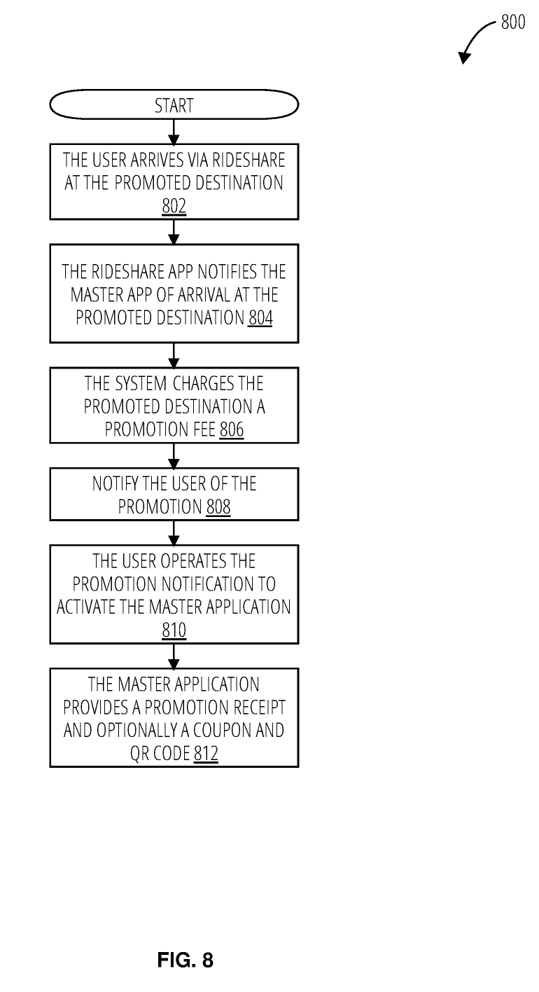

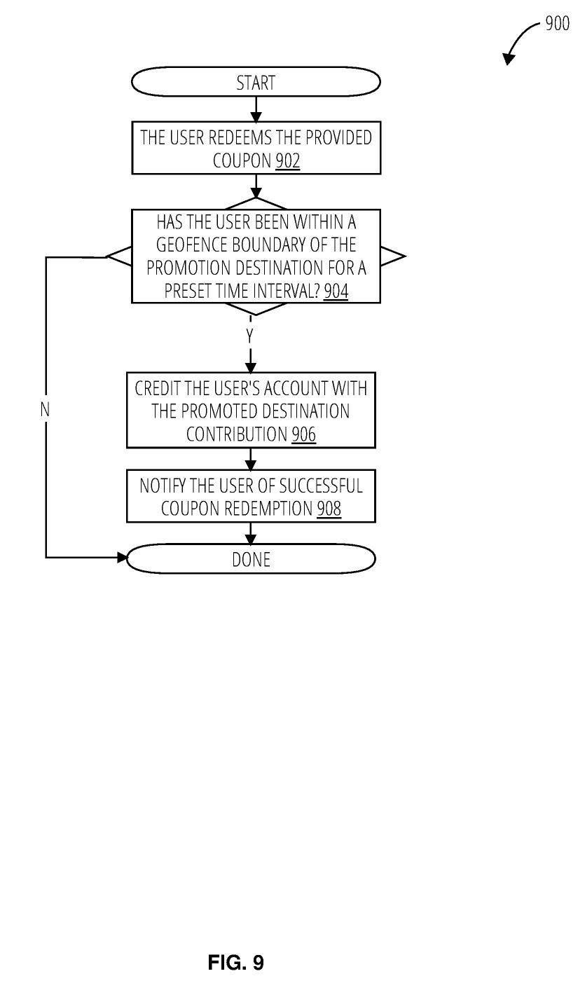

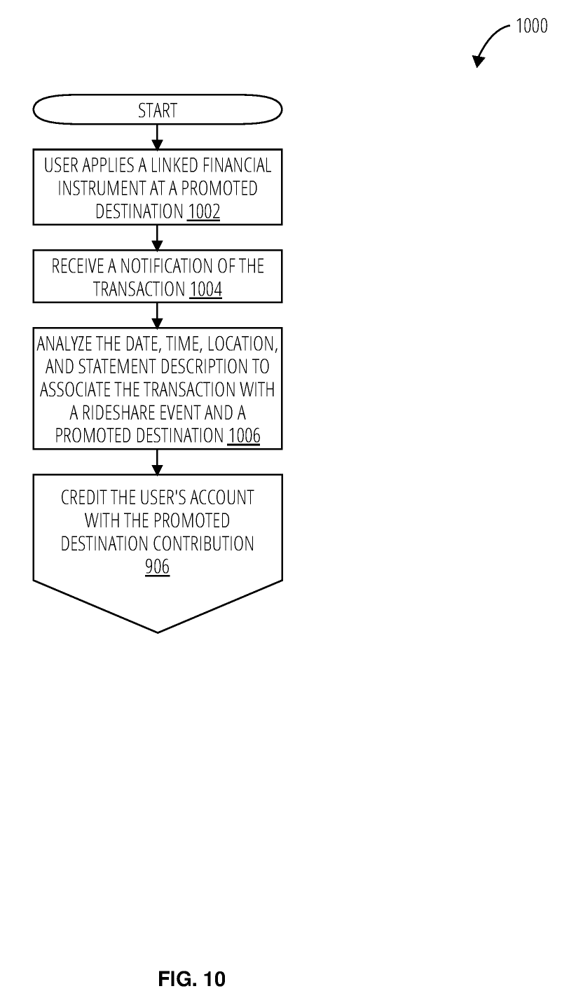

Referring to FIG. 2, a client device 106 includes a master application 202 and a rideshare application 204. The master application 202 may be invoked to override the configuration of the rideshare application 204; particularly, the master application 202 may override a destination location configured into the rideshare application 204. The master application 202 may be operated in accordance with the processes depicted in FIG. 5, FIG. 6, FIG. 7, FIG. 8, FIG. 9, and FIG. 10.

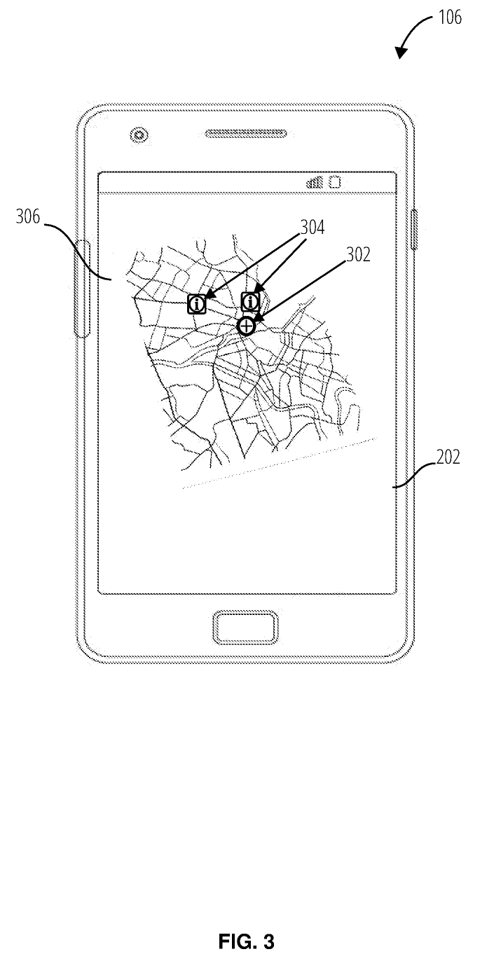

Referring to FIG. 3, the client device 106 executes the master application 202, which displays a geographic map and a current rideshare destination 302 with proximate promoted destinations 304 on the user interface 306. The user of the master application 202 is motivated to select one of the promoted destinations 304 for use with the rideshare application 204. The user interface 306 displays promotion controls associated with each of the promoted destinations 304. Upon a successful selection of one of the promoted destinations 304, the rideshare application 204 is reconfigured with the selected promoted destination (i.e., a selected destination), which overrides the destination currently configured in the rideshare application 204.

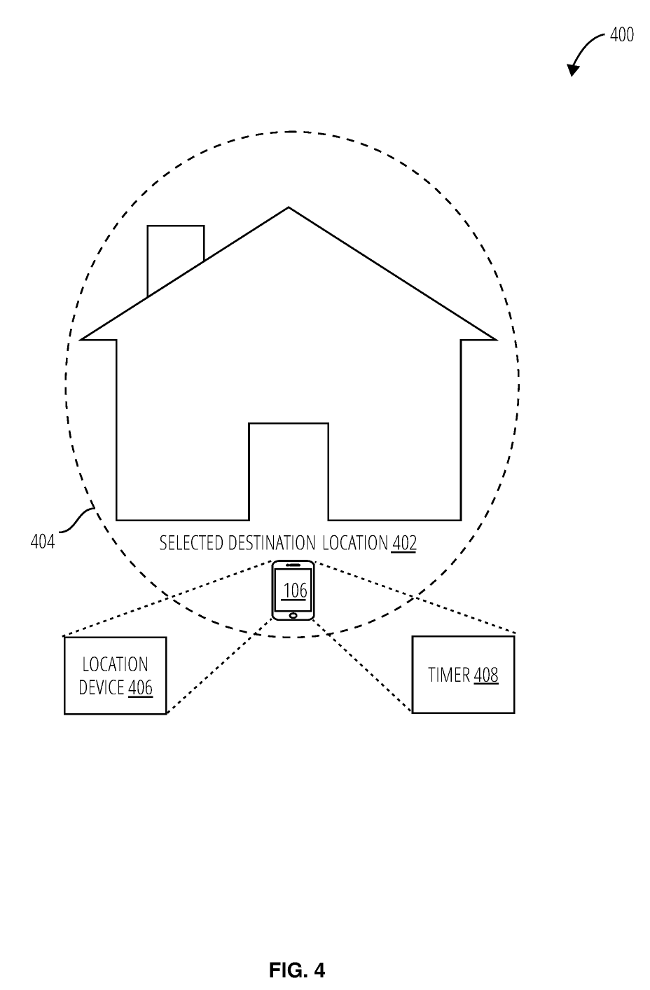

Referring to FIG. 4, a selected destination environment 400 comprises a client device 106, a selected destination location 402, and a geofence boundary 404. The client device 106 further comprises a location device 406 and a timer 408.

The selected destination location 402 is a physical area associated with the selected destination. The selected destination location 402 is further associated with a geofence boundary 404. The geofence boundary 404 may be a set of GPS coordinates associated with the selected destination location 402. The geofence boundary 404 may be smaller then or larger than the selected destination location 402. The client device 106 may be located within the geofence boundary 404.

The client device 106 may comprise a location device 406 to determine whether the client device 106 is located within the geofence boundary 404. In some embodiments, the master application may utilize the location of the client device 106 within the geofence boundary 404 to perform an operation, such as, crediting an account associated with the master application with a promoted destination contribution.

The client device 106 may also comprise a timer 408. The timer 408 may determine the time from one event to another. The timer 408 may be operated when the client device 106 is located within the geofence boundary 404. The timer 408 may cease operating when the client device 106 is removed from the geofence boundary 404. The timer 408 may also cease operating when a preset time interval has passed. In some embodiments, the master application may utilize the time elapsed while the client device 106 is within the geofence boundary 404 to perform an operation, such as, crediting an account associated with the master application with a promoted destination contribution. The crediting may occur when the time elapse exceeds the preset time interval.

Referring to FIG. 5, the re-configuration method 500 receives an activation control to activate the master application (block 502). The activation control may be an input on a user interface of a device, operation of a rideshare application, receipt of a destination by the rideshare application, etc. Instructions are sent to the rideshare application to push a destination notification control to the master application (block 504). The destination notification control may comprise a destination selected in the rideshare application. The master application is reconfigured to display promotion controls on a user interface (block 506). The promotion controls may be associated with an area proximate with the destination and each operable to receive an input. A selected destination control is sent to the rideshare application in response to receiving the input at one of the promotion controls (block 508). The selected destination control may comprise instructions to alter the destination of the rideshare application to a selected destination. The selected destination may be associated with the one of the promotion controls selected. The user interface may send a promotion input control to the master application to indicate the selected destination.

In some embodiments, the promotion controls displayed may be altered by an influencer. The area destinations associated with the destination and the area proximate are determined. A destination time interval and/or a destination time period is determined for each of the area destinations. The destination time interval and the destination time period may be the same or different for each of the area destinations. A destination frequency within the destination time interval is determined for each of the area destinations. The destination frequency and the destination time period may then be utilized to influence the display of the promotion controls. A lower destination frequency for one of the area destinations may result in a greater influence for that one of the area destinations. The destination frequency may also affect a promoted destination contribution associated with each of the area destinations. A longer destination time period may result in a greater influence for that one of the area destinations. The destination time period may also affect a promoted destination contribution associated with each of the area destinations.

In other embodiments, a coupon may be utilized to perform further operations. A coupon may be associated with a device operating the master application. The coupon may also be associated with an account associated with the master application, and the account further associated with a device. Whether the device has been within a geofence boundary of the selected destination for a preset time interval is determined. If so, an account associated with the master application is credited with a promoted destination contribution. The device may be further operated to display a successful coupon redemption notification. A location device and a timer associated with the device may be utilized to determine whether the device has been within the geofence boundary of the selected destination for the preset time interval. Additionally, the device may be operated to display the coupon as a quick response or bar code. An account associated with the master application may be credited with a promoted destination contribution in response to receiving a notification that the quick response or bar code has been scanned. Further, the device may be operated display an input control to receive a periodically changing PIN code to redeem the coupon.

In further embodiments, a linked financial instrument may be associated with an account associated with the master application. The master application may determine whether the linked financial instrument was utilized for a transaction at the selected destination. If so, a promoted destination contribution may be credited to the account. The master application may analyze one or more of a date, a time, a location, and a statement description. The date, the time, the location, and the statement description may be retrieved from a server.

FIG. 6 illustrates a mobile application reconfiguration process 600 in accordance with one embodiment. When a user books a rideshare (e.g., Uber®), they are prompted for a destination. The system redirects the user to a new destination by associating the new destination with a promotion, acceptance of the promotion causing a rideshare application to be reconfigured with a new destination.

The process 600 may activate the master application (block 602). The master application may be activated by receiving an input to the device, by activation of the rideshare application, a destination being input to the rideshare application, etc. A category may be selected (block 604). The master application may display a number of controls on a user interface associated with each category. The promotion controls associated with the selected category are displayed for browsing (block 606). One of the promotion controls is selected (block 608). The device may receive an input at the user interface associated with one of the promotion controls. The input may be a haptic input, audio input, etc. The new selected destination is sent to the rideshare application (block 610).

In some embodiments, the selected destination may be notified with the promotion configuration (block 612). The user may be notified of the reservation at the selected destination (block 614). The device may configure the user interface to display a notification.

The process 600 thus uses a master application (typically, a mobile device app) to control and change a destination configured into a rideshare application (such as Uber).

Referring to FIG. 7, the destination configured in a rideshare application may be reconfigured by a master application using a process 700. The rideshare application is launched (block 702). A destination is input to the rideshare application (block 704). A destination notification is pushed to the master application (block 706). The notification control operates to activate the master application (block 708). Promotions associated with an area proximate with the selected destination are presented (block 710). The destination configured in the rideshare application is changed to a selected destination associated with the selected promotion (block 712).

Thus the process 700 may be utilized to re-direct a user of a master application to a different destination that is then used to override the destination configured in a rideshare application.

FIG. 8 illustrates a process 800 executed at arrival at a promoted destination, in accordance with one embodiment. The user arrives via rideshare at the promoted destination (block 802). The rideshare application notifies the master application of arrival at the promoted destination (block 804). The system charges the promoted destination a promotion fee (block 806). The user is notified of the promotion (block 808). The user operates the promotion notification to activate the master application (block 810). The master application provides a promotion receipt and optionally a coupon and QR code (block 812).

The promotion is thus paid for by businesses or other venues seeking to attract people via ridesharing. Steps may then be taken to encourage the beneficiary of the promotion (the master application user) to engage with the promoter's facilities for a reasonable period of time, which will help ensure the promoter is compensated by the patronage of the user.

Referring to FIG. 9, a resource allocation process 900 is disclosed to credit a user's account for reconfiguration of a rideshare application 204 and attendance at a promoted destination.

The user redeems the provided coupon (block 902). The resource allocation process 900 determines whether the user has been within a geofence boundary of the promotion destination for a preset time interval (decision block 904). The master application 202 may instruct the user to remain within the geofenced boundary for a specified amount of time, and may monitor and time their presence there and warn them if they stray outside the boundary. If the user leaves the boundary, the timer may be reset, and eventually the promotion offer is canceled if they remain outside the boundary for too long. If the consumer stays inside the geofenced boundary for an amount of time configured for the particular promoted destination for the offer, then the user's account is credited with the promoted destination contribution (block 906). The user is notified of successful coupon redemption (block 908).

Various manners of redeeming the coupon may be implemented. For example, after completing their ride, the coupon may be digitally displayed within the user interface of the master application 202. The user may present the coupon at one of the promoted destinations 304. An operator presented with the coupon may redeem the coupon for example using one of the following methods: (i) the coupon is scanned (e.g., as a quick response or bar code displayed by the master application 202) by the operator; (ii) the user of the master application may input a periodically changing PIN code that redeems the coupon; or (iii) the operator may manually closeout the offer, e.g., using a tablet computer, point of sale device, or other mechanism.

The coupon may be automatically redeemed in one embodiment, as per FIG. 10.

In some implementations, the user may leave the geofence boundary prior to the elapse of the preset time interval and redeem the coupon. Instead, after the rideshare application 204 indicates conclusion of the ride, the system automatically redeems the coupon. This is for advertisers and marketing partners that want to provide value to their customers without enforcing a timed presence at the promoted location.

Referring to FIG. 10, an automated resource allocation 1000 may be carried out based on financial instruments associated with (linked to) the master application 202 via a user's account. The user applies a linked financial instrument at a promoted destination (block 1002). For example, their credit or debit card is swiped to pay a bill at the promoted destination. The system then receives a notification of the transaction (block 1004). The notification may be receiver from a server. The system analyzes the date, time, location, and statement description to associate the transaction with a rideshare event and a promoted destination (block 1006). The user's account is credited with the promoted destination contribution (block 906), as per FIG. 9.

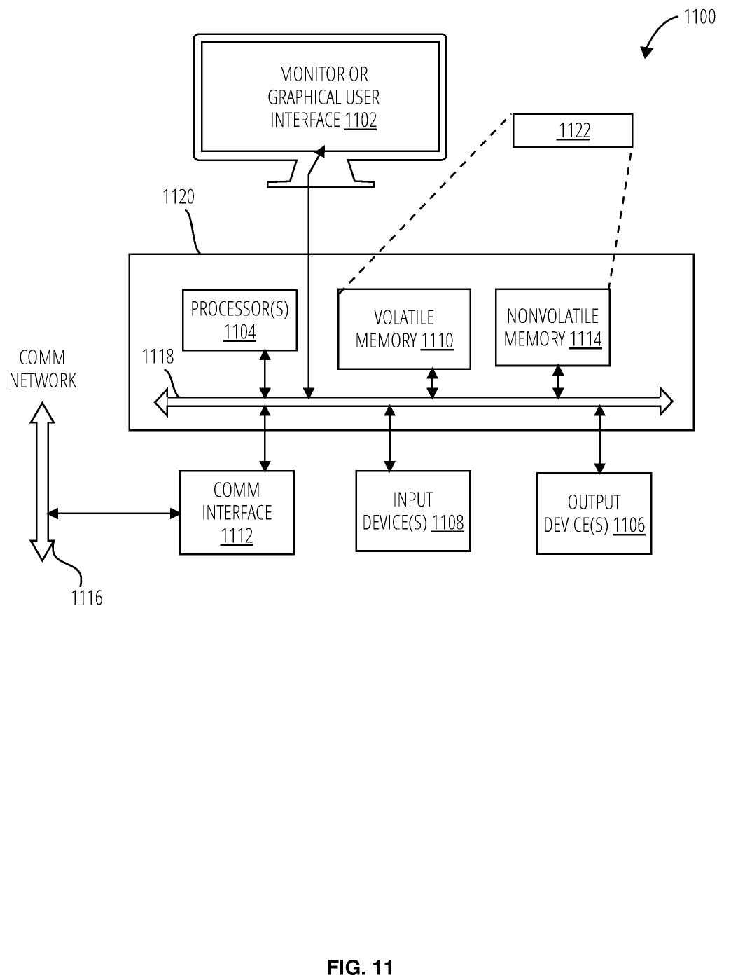

FIG. 11 is an example block diagram of a computing device 1100 that may incorporate embodiments of the present invention. FIG. 11 is merely illustrative of a machine system to carry out aspects of the technical processes described herein, and does not limit the scope of the claims. One of ordinary skill in the art would recognize other variations, modifications, and alternatives. In one embodiment, the computing device 1100 typically includes a monitor or graphical user interface 1102, a data processing system 1120, a communication network interface 1112, input device(s) 1108, output device(s) 1106, and the like.

As depicted in FIG. 11, the data processing system 1120 may include one or more processor(s) 1104 that communicate with a number of peripheral devices via a bus subsystem 1118. These peripheral devices may include input device(s) 1108, output device(s) 1106, communication network interface 1112, and a storage subsystem, such as a volatile memory 1110 and a nonvolatile memory 1114.

The volatile memory 1110 and/or the nonvolatile memory 1114 may store computer-executable instructions and thus forming logic 1122 that when applied to and executed by the processor(s) 1104 implement aspects of the processes disclosed herein (e.g., those implemented on the server 104).

The input device(s) 1108 include devices and mechanisms for inputting information to the data processing system 1120. These may include a keyboard, a keypad, a touch screen incorporated into the monitor or graphical user interface 1102, audio input devices such as voice recognition systems, microphones, and other types of input devices. In various embodiments, the input device(s) 1108 may be embodied as a computer mouse, a trackball, a track pad, a joystick, wireless remote, drawing tablet, voice command system, eye tracking system, and the like. The input device(s) 1108 typically allow a user to select objects, icons, control areas, text and the like that appear on the monitor or graphical user interface 1102 via a command such as a click of a button or the like.

The output device(s) 1106 include devices and mechanisms for outputting information from the data processing system 1120. These may include speakers, printers, infrared LEDs, and so on as well understood in the art.

The communication network interface 1112 provides an interface to communication networks (e.g., communication network 1116) and devices external to the data processing system 1120. The communication network interface 1112 may serve as an interface for receiving data from and transmitting data to other systems. Embodiments of the communication network interface 1112 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1112 may be coupled to the communication network 1116 via an antenna, a cable, or the like. In some embodiments, the communication network interface 1112 may be physically integrated on a circuit board of the data processing system 1120, or in some cases may be implemented in software or firmware, such as “soft modems”, or the like.

The computing device 1100 may include logic that enables communications over a network using protocols such as HTTP, TCP/IP, RTP/RTSP, IPX, UDP and the like.

The volatile memory 1110 and the nonvolatile memory 1114 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1110 and the nonvolatile memory 1114 may be configured to store the basic programming and data constructs that provide the functionality of the disclosed processes and other embodiments thereof that fall within the scope of the present invention.

Software that implements embodiments of the present invention may be stored in the volatile memory 1110 and/or the nonvolatile memory 1114. Said software may be read from the volatile memory 1110 and/or nonvolatile memory 1114 and executed by the processor(s) 1104. The volatile memory 1110 and the nonvolatile memory 1114 may also provide a repository for storing data used by the software.

The volatile memory 1110 and the nonvolatile memory 1114 may include a number of memories including a main random access memory (RAM) for storage of instructions and data during program execution and a read only memory (ROM) in which read-only non-transitory instructions are stored. The volatile memory 1110 and the nonvolatile memory 1114 may include a file storage subsystem providing persistent (non-volatile) storage for program and data files. The volatile memory 1110 and the nonvolatile memory 1114 may include removable storage systems, such as removable flash memory.

The bus subsystem 1118 provides a mechanism for enabling the various components and subsystems of data processing system 1120 communicate with each other as intended. Although the communication network interface 1112 is depicted schematically as a single bus, some embodiments of the bus subsystem 1118 may utilize multiple distinct busses.

It will be readily apparent to one of ordinary skill in the art that the computing device 1100 may be a mobile device such as a smartphone, a desktop computer, a laptop computer, a rack-mounted computer system, a computer server, or a tablet computer device. As commonly known in the art, the computing device 1100 may be implemented as a collection of multiple networked computing devices. Further, the computing device 1100 will typically include operating system logic (not illustrated) the types and nature of which are well known in the art.

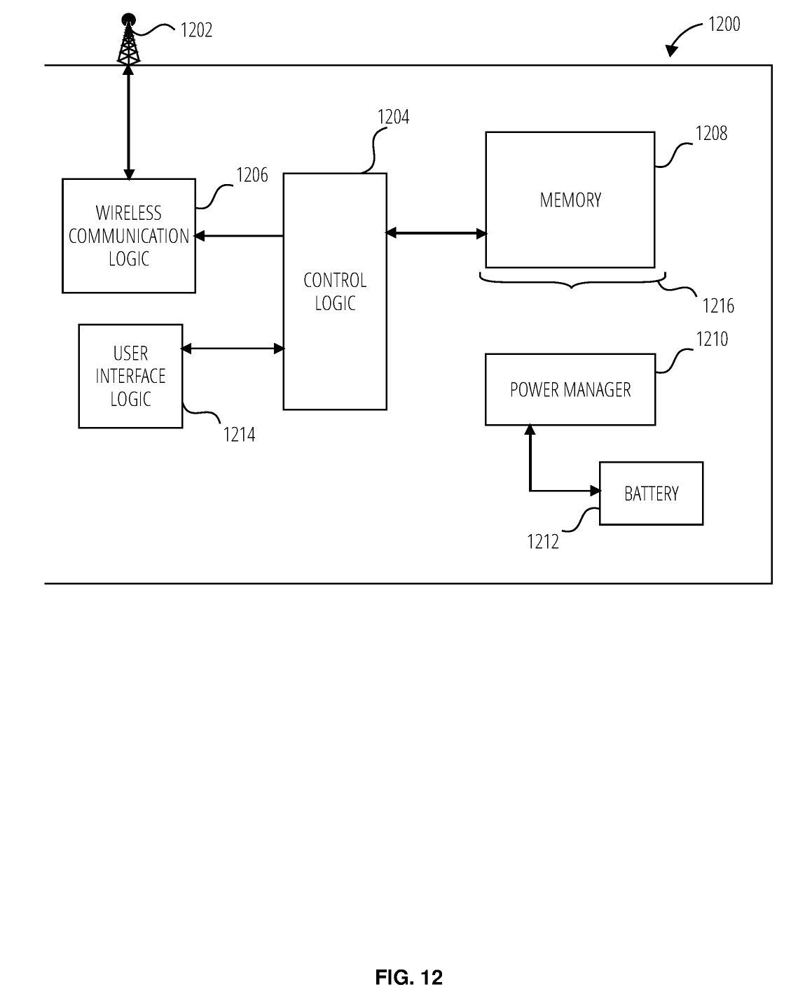

Referring to FIG. 12, a mobile device 1200 comprises an antenna 1202, control logic 1204, wireless communication logic 1206, a memory 1208, a power manager 1210, a battery 1212, logic 1216, and user interface logic 1214.

The control logic 1204 controls and coordinates the operation of other components as well as providing signal processing for the mobile device 1200. For example control logic 1204 may extract baseband signals from radio frequency signals received from the wireless communication logic 1206 logic, and processes baseband signals up to radio frequency signals for communications transmitted to the wireless communication logic 1206 logic. Control logic 1204 may comprise a central processing unit, digital signal processor, and/or one or more controllers or combinations of these components.

The wireless communication logic 1206 may further comprise memory 1208 which may be utilized by the control logic 1204 to read and write instructions (commands) and data (operands for the instructions). The memory 1208 may comprise logic 1216 to carry out aspects of the processes disclosed herein, e.g., those aspects executed by a smart phone or other mobile device.

A human user or operator of the mobile device 1200 may utilize the user interface logic 1214 to receive information from and input information to the mobile device 1200. Images, video and other display information, for example, user interface optical patterns, may be output to the user interface logic 1214, which may for example operate as a liquid crystal display or may utilize other optical output technology. The user interface logic 1214 may also operate as a user input device, being touch sensitive where contact or close contact by a use's finger or other device handled by the user may be detected by transducers. An area of contact or proximity to the user interface logic 1214 may also be detected by transducers and this information may be supplied to the control logic 1204 to affect the internal operation of the mobile device 1200 and to influence control and operation of its various components.

Audio signals may be provided to user interface logic 1214 from which signals output to one and more speakers to create pressure waves in the external environment representing the audio. The mobile device 1200 may convert audio phenomenon from the environment into internal electro or optical signals by operating a microphone and audio circuit (not illustrated).

The mobile device 1200 may operate on power received from a battery 1212. The battery 1212 capability and energy supply may be managed by a power manager 1210.

The mobile device 1200 may transmit wireless signals of various types and range (e.g., cellular, GPS, WiFi, BlueTooth, and near field communication i.e. NFC). The mobile device 1200 may also receive these types of wireless signals. Wireless signals are transmitted and received using wireless communication logic 1206 logic coupled to one or more antenna 1202. Other forms of electromagnetic radiation may be used to interact with proximate devices, such as infrared (not illustrated).

“Account” in this context refers to an association between a user, or information regarding a user, and a computer, website, or application.

“Application” in this context refers to a program or piece of software designed and written to fulfill a particular purpose of the user.

“Area proximate” in this context refers to a geographic distance from a location, e.g., a radius about a location, or other shape.

“Associator” in this context refers to a correlator (see the definition for Correlator).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Classifier” in this context refers to a specific type of correlator/associator logic that associates one or more inputs with a category, class, or other group sharing one or more common characteristics. An example of a classifier that may commonly be implemented in programmable hardware is a packet classifier used in network switches, firewalls, and routers (e.g., packet classifiers utilizing Ternary Content Addressable Memories). An example software or firmware classifier is: if (input1.value<12.5) input1.group=group1; else if (input1.value>=12.5 and input1.value<98.1) input1.group=group2; else input1.group=group3; Other examples of classifiers will be readily apparent to those of skill in the art, without undo experimentation.

“Combiner” in this context refers to a logic element that combines two or more inputs into fewer (often a single) output. Example hardware combiners are arithmetic units (adders, multipliers, etc.), time-division multiplexers, and analog or digital modulators (these may also be implemented is software or firmware). Another type of combiner builds an association table or structure (e.g., a data structure instance having members set to the input values) in memory for its inputs. For example: val1, val2, val3->combiner logic->{val1, val2, val3} set.val1=val1; set.val2=val2; set.val3=val3; Other examples of combiners will be evident to those of skill in the art without undo experimentation.

“Comparator” in this context refers to a logic element that compares two or more inputs to produce one or more outputs that reflects similarity or difference of the inputs. An example of a hardware comparator is an operational amplifier that outputs a signal indicating whether one input is greater, less than, or about equal to the other. An example software or firmware comparator is: if (input1==input2) output=val1; else if (input1>input2) output=val2; else output=val3; Many other examples of comparators will be evident to those of skill in the art, without undo experimentation.

“Control (or control signal)” in this context refers to a pulse or frequency of electricity or light that represents a control command as it travels over a network, a computer channel or wireless.

“Correlator” in this context refers to a logic element that identifies a configured association between its inputs. One examples of a correlator is a lookup table (LUT) configured in software or firmware. For example: |low_alarm_condition|low_threshold_value|0| |safe_condition|safe_lower_bound|safe_upper_bound| |high_alarm_condition|high_threshold_value|0| Generally, a correlator receives two or more inputs and produces an output indicative of a mutual relationship or connection between the inputs. Examples of correlators that do not use LUTs include any of a broad class of statistical correlators that identify dependence between input variables, often the extent to which two input variables have a linear relationship with each other. One commonly used statistical correlator is one that computes Pearson's product-moment coefficient for two input variables (e.g., two digital or analog input signals). Other well-known correlators compute a distance correlation, Spearman's rank correlation, a randomized dependence correlation, and Kendall's rank correlation. Many other examples of correlators will be evident to those of skill in the art, without undo experimentation.

“Destination” in this context refers to a digital representation of a physical place, e.g., a marker on an electronic map.

“Destination frequency” in this context refers to a number of times a particular destination has been associated with the master application.

“Destination time interval” in this context refers to a measure of time over which the destination frequency is determined for each destination.

“Destination time period” in this context refers to a measure of time from when the master application was last associated with the destination.

“Firmware” in this context refers to software logic embodied as processor-executable instructions stored in read-only memories or media.

“Geofence boundary” in this context refers to a virtual perimeter for a real-world geographic area, which may be dynamically generated—as in a radius around a store or point location, or a geo-fence may be a predefined set of boundaries, such as school attendance zones or neighborhood boundaries.

“Hardware” in this context refers to logic embodied as analog or digital circuitry.

“Influence” in this context refers to an increase or decrease in the likelihood of the display of a particular promoted destination.

“Linked financial instrument” in this context refers to part of a payment system that enables its owner to send and receive a payment by a transfer, such as a electronic funds transfer, that is associated with the master application.

“Location device” in this context refers to a device that is capable of receiving information to calculate the device's geographical position, such as a Global Positioning System receiver.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Parser” in this context refers to logic that divides an amalgamated input sequence or structure into multiple individual elements. Example hardware parsers are packet header parsers in network routers and switches. An example software or firmware parser is: aFields=split(“val1, val2, val3”, “,”); Another example of a software or firmware parser is: readFromSensor gpsCoordinate; x_pos=gpsCoordinate.x; y_pos=gpsCoordinate.y; z_pos=gpsCoordinate.z; Other examples of parsers will be readily apparent to those of skill in the art, without undo experimentation.

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Quick response or bar code” in this context refers to an optical, machine-readable, representation of data; the data usually describing something about the object that carries the barcode.

“Selector” in this context refers to a logic element that selects one of two or more inputs to its output as determined by one or more selection controls. Examples of hardware selectors are multiplexers and demultiplexers. An example software or firmware selector is: if (selection_control==true) output=input1; else output=input2; Many other examples of selectors will be evident to those of skill in the art, without undo experimentation.

“Software” in this context refers to logic implemented as processor-executable instructions in a machine memory (e.g. read/write volatile or nonvolatile memory or media).

“Switch” in this context refers to logic to select one or more inputs to one or more outputs under control of one or more selection signals. Examples of hardware switches are mechanical electrical switches for switching power to circuits, devices (e.g., lighting), or motors. Other examples of hardware switches are solid-state switches such as transistors. An example of a hardware or firmware switch is: if (selection==true) output=input; else output=0; A somewhat more complicated software/firmware switch is: if (selection1==true and selection2==true) output=input1; else if (selection1==true and selection2==false) output=input2; else if (selection1==false and selection2==true) output=input3; else output=noOp; Switches operate similarly to selectors in many ways (see the definition of Selector), except in some cases switches may select all inputs to the output, (s) not select among inputs. Other examples of switches will be readily apparent to those having skill in the art, without undo experimentation.

“Timer” in this context refers to a device which may determine a measure of time of operation.

“User interface” in this context refers to the means by which the user and a computer system interact, in particular the use of input devices and software.

What is claimed is:

1. A method of reconfiguring a rideshare application from a master application, the method comprising:
receiving an activation control to activate the master application;
sending first instructions to the rideshare application to push a destination notification control to the master application, the destination notification control comprising a destination selected in the rideshare application;
re-configuring the master application to display promotion controls on a user interface, the promotion controls associated with an area proximate with the destination and each operable to receive an input; and
sending a selected destination control to the rideshare application in response to receiving the input at one of the promotion controls, the selected destination control comprising second instructions to alter the destination of the rideshare application to a selected destination, the selected destination associated with the one of the promotion controls selected.

2. The method of claim 1, further comprising:
determining area destinations associated with the destination and the area proximate;
determining a destination time interval for each of the area destinations;
determining a destination frequency within the destination time interval for each of the area destinations; and
influencing the promotion controls displayed based on the destination frequency of each of the area destinations.

3. The method of claim 2, wherein a lower destination frequency for one of the area destinations results in a greater influence for that one of the area destinations.

4. The method of claim 2, wherein the destination frequency affects a promoted destination contribution associated with each of the area destinations.

5. The method of claim 1, further comprising:
determining area destinations associated with the destination and the area proximate;
determining a destination time period for each of the area destinations; and
influencing the promotion controls displayed based on the destination time period of each of the area destinations.

6. The method of claim 5, wherein a longer destination time period results in a greater influence for that one of the area destinations.

7. The method of claim 5, wherein the destination time period affects a promoted destination contribution associated with each of the area destinations.

8. The method of claim 1, further comprising:
associating a coupon with a device operating the master application;
determining whether the device has been within a geofence boundary of the selected destination for a preset time interval; and
in response to the device being within the geofence boundary of the selected destination for the preset time interval, crediting an account associated with the master application with a promoted destination contribution.

9. The method of claim 8, further comprising:
operating the device to display a successful coupon redemption notification.

10. The method of claim 8, wherein a location device and a timer associated with the device are utilized to determine whether the device has been within the geofence boundary of the selected destination for the preset time interval.

11. The method of claim 1, further comprising:
associating a coupon with a device operating the master application; and
operating the device to display the coupon as a quick response or bar code.

12. The method of claim 11, crediting an account associated with the master application with a promoted destination contribution in response to receiving a notification that the quick response or bar code has been scanned.

13. The method of claim 1, further comprising:
associating a coupon with a device operating the master application; and
displaying an input control on the device to receive a periodically changing PIN code to redeem the coupon.

14. The method of claim 1, further comprising:
associating a linked financial instrument with an account associated with the master application;
determining the linked financial instrument was utilized for a transaction at the selected destination; and
crediting a promoted destination contribution to the account.

15. The method of claim 14, wherein determining the linked financial instrument was utilized for the transaction at the selected destination comprises analyzing one or more of a date, a time, a location, and a statement description.

16. A system comprising:
a master application to:
receive an activation control;
send first instructions to a rideshare application to push a destination notification control to the master application, the destination notification control comprising a destination selected in the rideshare application;
determine promotion controls associated with an area proximate with the destination;
receive a promotion input control; and
send a selected destination control to the rideshare application in response to receiving the promotion input control, the selected destination control comprising second instructions to alter the destination of the rideshare application to a selected destination, the selected destination associated with the one of the promotion controls associated with the promotion input control; and
a user interface to:
display the promotion controls associated with the area proximate with the destination;
associate an input with one of the promotion controls; and
send the promotion input control to the master application, the promotion input control associated with the one of the promotion controls associated with the input.

17. The system of claim 16, further comprising a timer to determine one or more of a destination time interval and a destination time period associated with each of the promotion controls and an influencer to alter the promotion controls determined based on the destination time interval and the destination time period.

18. The system of claim 16, further comprising a location device and a timer to determine whether a device associated with the master application has been within a geofence boundary of the selected destination for a preset time interval.

19. The system of claim 16, a server to send one or more of a date, a time, a location, and a statement description of a transaction at the selected destination.

20. The system of claim 16, wherein the user interface is further displays one or more of:
a successful coupon redemption notification;
a quick response or bar code; and
an input control to receive a periodically changing PIN code.
